(19) United States
(12) Patent Application Publication
(10) Pub. No.: US 2002/0058534 A1
(43) Pub. Date: May 16, 2002

(54) Method and apparatus for blocking an operation involving two identifiers

(75) Inventors: Romain Durand, Paris (FR); Jean-Luc Pellegrinelli, Paris (FR)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/865,532

(22) Filed: May 29, 2001

(30) Foreign Application Priority Data
May 30, 2000 (FR) 00 06 957

(51) Int. Cl. H04M 1/00

(52) U.S. Cl. 455/558; 455/411

(57) ABSTRACT

A method of blocking an operation or a service involving a first identifier including first information suitable for being read by first reader means disposed in a radio terminal and a second identifier including second information suitable for being read by second reader means associated with the terminal, the method comprising the steps of:

calculating first data from the first and second information as read in the identifiers;

comparing the first calculated data with second data stored in a memory zone of the assembly comprising the terminal and the second read means; and

authorizing the operation involving both identifiers depending on the result of the comparison.

The present invention relates to a method and apparatus for blocking an operation involving two identifiers, such as a telecommunications service user card and a bank card, for example, a first identifier being suitable for placing in a radio terminal and a second identifier being suitable for insertion in a reader associated with the terminal.

The invention relates more particularly to the field of cellular radio terminals, e.g. operating under the standard known as GSM, by way of non-exclusive example.

### BACKGROUND OF THE INVENTION

In order to able to use a terminal, the user must place an identifier therein, which identifier contains various items of information such as the number of the subscriber or data relating to the telecommunications operator, for example.

In the GSM standard, the identifier is a user card known as a “subscriber identity module” (SIM) issued by an operator and including an international number (known as an IMSI number) together with data specific to the operator and suitable for being read by read means contained within the terminal.

Given the great expansion of radio technologies, new applications and new services are being devised, and in particular those associated with “e-commerce”.

The range of options made available to the user of radio terminal is becoming ever broader. In addition to being able to send and receive data (voice or other), a user can pay for purchases by means of the terminal.

For this to be possible, the terminal must be associated with a reader capable of decoding information contained in a second identifier which can be a bank card, for example (a smart card or a magnetic track card).

In the context of other applications, other cards containing personal information about the user could be used, such as health cards, electronic purses, loyalty cards, . . . .

The reader associated with the second card is different from the means for reading the SIM card which belong to the terminal, and it can be associated with the terminal using various known techniques. The reader comprises an accessory which is completely independent and which is connected to the terminal (by cable or directly to a port of said terminal), or it can be integrated in the terminal or indeed it can be associated with a spare battery enabling the terminal to be powered electrically.

In the special case of bank cards, the user seeking to make payment via a radio terminal inserts the card into the reader associated with the terminal and then inputs the personal identification number (PIN) associated with the bank card. The terminal associated with the card reader thus acts as a payment terminal.

Certain readers of known type are dedicated to a particular type of terminal. A given terminal corresponds to a specific reader which cannot be used with any other model of terminal.

In the event of an operator or an institution, such as a bank for example, desiring to offer new services to customers associated with the use of this technology, it would be most advantageous to be able to provide those customers with a card reader of a type that is capable of operating with a variety of models of terminal while nevertheless seeking to reserve the use of such readers solely to the services provided.

In ordinary commercial operations, a telecommunications operator can be associated with another service provider such as a bank, etc., in order to make new services available.

However, when the customer uses the SIM card of that operator, the customer should be able to use only the bank card issued by the bank in question in order to access the services that are made available jointly by the operator and the bank.

Known terminal readers do not make it possible to restrict their use exclusively to one operator, one service provider, or any other given entity.

### OBJECTS AND SUMMARY OF THE INVENTION

In this context, an object of the present invention is to mitigate the above drawbacks by proposing a method making it possible to prevent the services of the supplier(s) of the reader or of the assembly comprising the terminal and the reader from being used unless the pair of cards, one in the reader and the other in the terminal, is the pair provided by the supplier(s), but without thereby blocking the reader or blocking normal operation of the terminal.

To this end, the invention provides a method of blocking an operation or a service involving a first identifier including first information suitable for being read by first reader means disposed in a radio terminal and a second identifier including second information suitable for being read by second reader means associated with the terminal, the method comprising the steps of:

calculating first data from the first and second information as read in the identifiers;

comparing the first calculated data with second data stored in a memory zone of the assembly comprising the terminal and the second read means; and

authorizing the operation involving both identifiers depending on the result of the comparison.

Advantageously, the steps of calculating, storing, and comparing the first and second data are implemented by means integrated in the radio terminal, or in the second read means.

Preferably, the first data is stored during a step of personalizing the terminal or the second reader means, and the method further includes a prior step of verifying whether the function of blocking the operation is in an activated state, which prior step is performed before performing the calculation and comparison steps.

In a preferred implementation of the invention, the first identifier suitable for being read by the radio terminal is a user card of the SIM type, and the second identifier suitable for being read by the second reader means associated with the radio terminal is a card of the smart card type or of the magnetic track type.

The invention also provides apparatus enabling an operation or a service involving first and second identifiers to be blocked, the apparatus comprising a radio terminal having first reader means suitable for reading first information coming from the first identifier, the terminal being associated with second reader means suitable for reading second information coming from the second identifier, the apparatus including means:

for calculating first data from first and second information read in the identifiers; and

for comparing the first calculated data with second data stored in storage means of the assembly comprising the terminal and the second reader means.

Advantageously, the means for calculating, storing, and comparing the first and second data are integrated in the radio terminal or in the second read means.

In a particular embodiment, the first and second identifiers are respectively a user card of the SIM card type and a smart card or a magnetic track card.

### BRIEF DESCRIPTION OF THE DRAWINGS

The invention will be better understood on reading the following description of an illustrative but in no way limiting embodiment, given with reference to the accompanying drawings, in which:

FIG. 1 is a simplified block diagram of the apparatus of the invention implementing the blocking method of the invention;

FIG. 2 is a flow chart of the blocking method of the invention; and

FIG. 3 is a detail of one of the steps of method of FIG. 2.

### MORE DETAILED DESCRIPTION

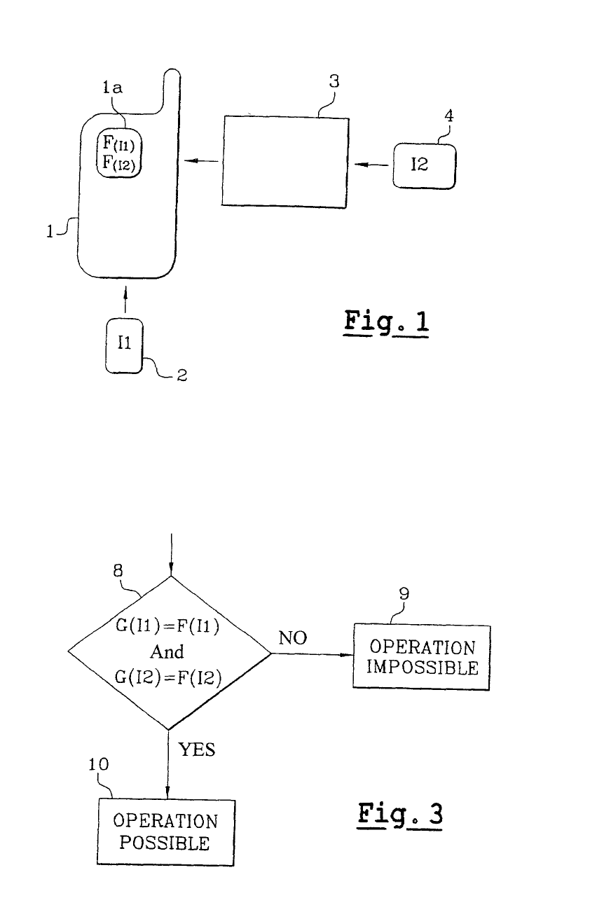

FIG. 1 is a simplified block diagram of the apparatus for implementing the method of the invention.

The apparatus comprises a radio terminal 1 of conventional type, suitable for receiving an identifier 2 of the SIM card type.

The terminal 1 includes known reader means (not shown) suitable for reading first information I1 contained in the SIM card 2.

The terminal 1 is also suitable for being associated in conventional manner with second reader means 3 for reading a second identifier 4.

In FIG. 1, the second reader means are constituted by a reader suitable for reading second information I2 contained in the second identifier 4. By way of example, the second identifier 4 can be constituted by a smart card, a magnetic track card, or any other module suitable for containing second information I2. In the description below, the card is assumed to be a smart card.

In the embodiment shown in FIG. 1, the terminal also has a memory zone la suitable for storing first data F(I1) and F(I2) relating respectively to the first and second information I1 and I2.

In another embodiment, this first data F(I1) and F(I2) could be stored in a memory zone in the reader 3.

The first data F(I1) and F(I2) is established from the first and second information I1 and I2 coming from the SIM card 2 and from the smart card 4 using an algorithm that is predetermined and defined during a personalization step described in greater detail with reference to FIG. 2.

The terminal 1 also has calculation means associated with a calculation function G, and comparator means, that are known in themselves and not shown, and that are described in greater detail with reference to FIG. 2.

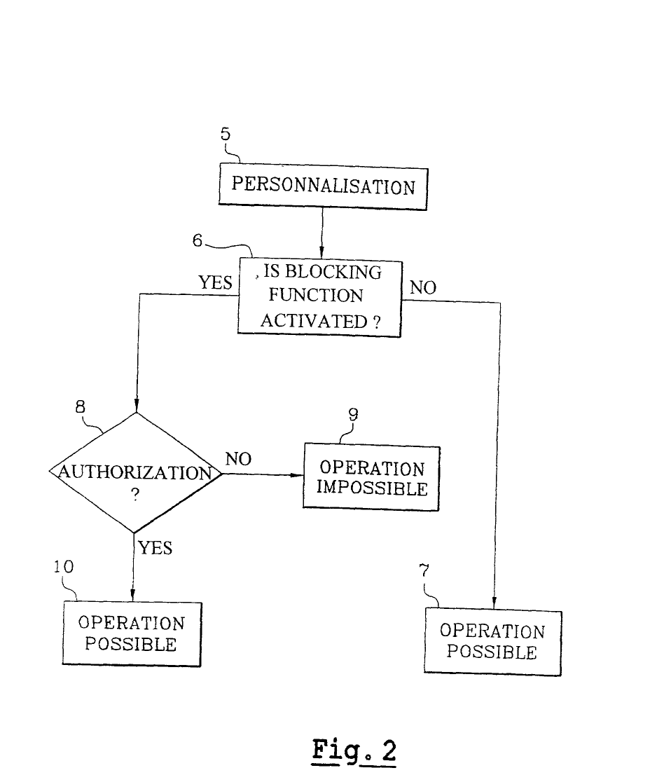

In the embodiment in which the reader 3 has a memory zone suitable for storing the first data F(I1) and F(I2), said reader 3 includes a microcontroller suitable for performing the calculation and comparison steps shown in detail in FIGS. 2 and 3.

FIG. 2 is a flow chart of the method of the invention.

Said method comprises a first step 5 of personalization during which the first data F(I1) and F(I2) is stored in the memory zone la of the terminal (or in a memory zone of the reader 3, depending on the embodiment used).

Depending on the type of data that is to be stored, this personalization step 5 can be implemented at the time said terminal 1 is manufactured, or it can be implemented subsequently, e.g. when the terminal 1 is first put into service.

The stored first data F(I1) and F(I2) depends directly on the first and second information I1 and I2 read from the SIM card 2 and from the smart card 4.

The information I1 and I2 as read, and the data F(I1) and F(I2) as stored can either be very general, such as the type of operator or the name of the bank issuing the smart card 4, for example, or else very particular such as the name of the holder of the SIM card 2 and/or of the smart card 4.

When the information to be stored is of a very general type, the personalization step 5 can be performed a long way upstream, e.g. during manufacture. However, if the information is more precise, then personalization step 5 is performed downstream of manufacture.

In an advantageous embodiment, the method of the invention further includes a prior step of verifying whether or not the function of blocking the operation involving both the SIM card 2 and the smart card 4 is activated.

The blocking function can be activated or deactivated using any known means, for example inputting a code via the keypad of the terminal 1 or directly by the operator using the radio network.

When the blocking function is not activated, the operation involving both identifiers, i.e. the SIM card 2 and the smart card 4 can be performed at any instant, and regardless of the first and second information I1 and I2 contained in the SIM card 2 and the smart card 4.

The apparatus comprising the terminal 1 in association with the reader 3 makes no discrimination between identifiers. Whatever the first data F(I1) and F(I2) stored in the terminal 1, operation is authorized even if the first and second information read from the SIM card 2 and the smart card 4 does not correspond to the first and second information I1 and I2.

When the blocking function is activated, then the method of the invention passes via an authorization stage 8.

The authorization stage 8 is described below in greater detail with reference to FIG. 3, and it is a decision-making stage during which various steps are performed possibly leading to an operation being authorized.

When authorization is refused, then an operation involving the SIM card 2 jointly with the smart card 4 cannot be performed (step 9).

This applies, for example, when the smart card 4 is a bank card and the operation is typically a payment operation. Payment cannot be performed unless the bank card 4 is the correct card.

If the bank card 4 is not the card intended to operate with the SIM card 2 as read by the terminal 1, then the second information I2 contained therein is not the correct information and it will not be recognized by the apparatus.

Conversely, if the bank card 4 contains the correct second information I2 but the SIM card 2 does not contain the correct first information I1, then the operation involving both identifiers 2 and 4 cannot be performed (step 9).

When both identifiers, in this example the SIM card 2 and the smart card 4 are correct, then authorization is given during the authorization stage 8. The operation involving the SIM card 2 in conjunction with the smart card 4 is then possible (step 10).

FIG. 3 shows the details of the decision stage 8 in FIG. 2.

This decision stage comprises a step of calculating second calculated data G(I1) and G(I2). This calculation step makes use of a calculation function G using the first and second information I1 and I2 as read from the SIM card 2 and the smart card 4, one of which is associated with the terminal and the other with the reader.

The calculation function G can be established in known manner using any given algorithm. In the embodiment described, this calculation function is integrated in the terminal 1, but it could equally well be integrated in the reader 3.

The blocking member then operates as follows:

The SIM card 2 containing first information I1 is inserted in the terminal 1 while the smart card 4 containing second information I2 is inserted in the reader 3 associated with the terminal 1.

In a memory zone 1a, the terminal 1 contains first stored data F(I1) and F(I2) relating to the first and second information contained in the identifiers 2 and 4.

Because of the respective reader means, the terminal 1 and the reader 3 can process the first and second information I1 and I2 from the first and second identifiers 2 and 4.

The terminal 1 then uses the calculation function G to calculate second data G(I1) and G(I2). This calculated data G(I1) and G(I2) is then compared with the stored data F(I1) and F(I2).

When there is a match, the terminal 1 associated with the reader 3 assumes that the correct SIM card 2 and the correct smart card 4 have been inserted and authorizes the operation that involves both identifiers 2 and 4 (step 10).

In the event of G(I1) being different from F(I1), or G(I2) being different from F(I2), then the terminal 1 does not authorize the operation since one of the two identifiers, either the SIM card 2 or the smart card 4 is not the identifier expected by the apparatus (step 9).

Thus, by using the blocking method of the invention, an operation involving two identifiers such as a SIM card 2 and a smart card 4 can be performed only if both identifiers (2, 4) correspond to the identifiers expected by the apparatus.

If either one of the two identifiers (2, 4) does not contain the correct information (I1, I2), then the terminal 1 in association with the reader 3 does not authorize the operation and therefore does not authorize use of the service that requires both identifiers to be present simultaneously.

It should be observed that blocking the second card (e.g. a bank card) does not prevent the radio telephone being used as a telephone (unless the SIM card is also blocked or locked).

1. A method of blocking an operation or a service involving a first identifier including first information suitable for being read by first reader means disposed in a radio terminal and a second identifier including second information suitable for being read by second reader means associated with the terminal, the method comprising the steps of:
calculating first data from the first and second information as read in the identifiers;
comparing the first calculated data with second data stored in a memory zone of the assembly comprising the terminal and the second read means; and
authorizing the operation involving both identifiers depending on the result of the comparison.

2. A method according to claim 1, wherein the steps of calculating, storing, and comparing the first and second data are implemented by means integrated in the radio terminal.

3. A method according to claim 1, wherein the steps of calculating, storing, and comparing the first and second data are implemented by means integrated in the second reader means.

4. A method according to claim 1, wherein the first data is stored during a step of personalizing the terminal or the second reader means.

5. A method according to claim 1, further including a prior step of verifying whether the function of blocking the operation is in an activated state, which prior step is performed before performing the calculation and comparison steps.

6. A method according to claim 1, wherein the first identifier suitable for being read by the radio terminal is a user card of the SIM type.

7. A method according to claim 1, wherein the second identifier suitable for being read by the second reader means associated with the radio terminal is a card of the smart card type or of the magnetic track type.

8. Apparatus enabling an operation or a service involving first and second identifiers to be blocked, the apparatus comprising a radio terminal having first reader means suitable for reading first information coming from the first identifier, the terminal being associated with second reader means suitable for reading second information coming from the second identifier, the apparatus including means:
for calculating first data from first and second information read in the identifiers; and
for comparing the first calculated data with second data stored in storage means of the assembly comprising the terminal and the second reader means.

9. Apparatus according to claim 8, wherein the means for calculating, storing, and comparing the first and second data are integrated in the radio terminal.

10. Apparatus according to claim 8, wherein the means for calculating, storing, and comparing the first and second data are integrated in the second reader means.

11. Apparatus according to claim 8, wherein the first and second identifiers are respectively a user card of the SIM card type and a smart card or a magnetic track card.
